(19) United States
(12) Patent Application Publication
(10) Pub. No.: US 2003/0015257 A1
(43) Pub. Date: Jan. 23, 2003

(54) Flux cored wire for gas shielded arc welding of high tensile strength steel

(75) Inventors: Jongwon Kim, Changwon City (KR); Chulkyu Park, Changwon City (KR)

Correspondence Address: Eugene Mar, BACON & THOMAS, PLLC, Fourth Floor, 625 Slaters Lane, Alexandria, VA, 22314-1176, US

(73) Assignee: KISWEL LTD, Changwon City (KR)

(21) Appl. No.: 10/153,894

(22) Filed: May 24, 2002

(30) Foreign Application Priority Data
May 28, 2001 (KR) 2001-29473

(51) Int. Cl. B23K 35/34

(52) U.S. Cl. 148/24

(57) ABSTRACT

Disclosed is a flux cored wire for gas shielded arc welding of high tensile strength steel, characterized in that the flux essentially consists of, with respect to the total weight of the wire: metal or ferroalloy containing at least Si, Mg and Al acting as a deoxidizing agent, the sum of the three components, Si, Mg and Al being from 0.5 to 1.5%; from 1.5 to 2.7% Mn, provided that the ratio of Mn to (Mg+Al), i.e., the value of Mn/(Mg+Al) is 3.5-5.0; from 2.5 to 9.0% TiO₂ and from 0.5 to 2.0% SiO₂, as a slag forming agent; and two or more components selected from the group consisting of Cr, Ni, Mo and Nb, the sum of the two or more components being 1.0-2.5%. The flux cored wire exhibits good welding workability in all welding positions, ensuring an improvement in the efficiency of welding work, and maintains high tensile strength and impact absorption energy, ensuring stability of welded structures.

### BACKGROUND OF THE INVENTION

1. Field of the Invention

The present invention relates to a flux cored wire for gas shielded arc welding of high tensile strength steel of 80 kgf/mm² grade, and more particularly, to a flux cored wire for gas shielded arc welding of high tensile strength steel of 80 kgf/mm² grade, which exhibits improved workability and low temperature impact toughness resulting from filling a titania based flux in the wire.

2. Description of the Related Art

Tensile strength of most flux cored wires which have been mainly used for high tensile strength steel plates is in the range of 60-70 kgf/mm². Under such tensile strength, however, it is difficult not only to maintain high strength, but also to maintain excellent elongation and cold toughness. Up until now, in order to satisfy all of high strength, excellent elongation and low temperature impact toughness, shielded arc welding electrodes or basic flux cored wires have been mainly used. However, there are problems in that the shielded arc welding electrodes and the basic flux cored wires have a limited applicability and poor workability.

Meanwhile, titania based flux cored wires can be substituted for the basic flux cored wires. In this case, however, a problem may occur that although added TiO₂s along with other oxides produce slag and the resultant slag covers the surface of a bead, only a few of the TiO₂s are present in an interior of weld metal as a non-metallic inclusion, making it possible to increase the amount of oxygen in the weld metal, whereby the toughness of the weld metal is lowered.

### SUMMARY OF THE INVENTION

Therefore, the present invention has been made in view of the above problems, and it is an object of the present invention to provide a flux cored wire for gas shielded arc welding of high tensile strength steel, which is excellent in workability and low temperature impact toughness property and has more than 80 kgf/mm² of high tensile strength.

In accordance with the present invention, the above object can be accomplished by the provision of a flux cored wire for gas shielded arc welding, characterized in that the flux essentially consists of, with respect to the total weight of the wire:

metal or ferroalloy containing at least Si, Mg and Al acting as a deoxidizing agent, the sum of the Si, Mg and Al being from 0.5 to 1.5%,

from 1.5 to 2.7% Mn, provided that the ratio of Mn to (Mg+Al), i.e., the value of Mn/(Mg+Al), is 3.5-5.0,

from 2.5 to 9.0% TiO₂ and from 0.5 to 2.0% SiO₂, as a slag forming agent, and

two or more components selected from the group consisting of Cr, Ni, Mo and Nb, the sum of the two or more components being 1.0-2.5%.

In accordance with the present invention, there is provided a flux cored wire, which has excellent workability and a Charpy V-notched impact property of more than 27J at 0, as well as maintains a high tensile strength of more than 80 kgf/mm² grade.

To meet the above characteristics, it is necessary to make the matrix of weld metal more fine. To this, it is important to adjust the components of the flux and its composition ratio appropriately.

Therefore, the present invention employs a titania based flux instead of a basic flux. Further, Ti or TiO₂ oxide and Si or SiO₂ oxide are appropriately used. Metal Mg and Al or alloy including them is also used in combination with conventional manganese metal, silicon metal or ferroalloy thereof as a deoxidizing agent, in order to prevent non-metallic inclusions from remaining in an interior of weld metal.

Also, to maintain excellent tensile strength and toughness properties, the flux may contain an alloying agent as an additive.

### DESCRIPTION OF THE PREFERRED EMBODIMENTS

The following will specifically describe the reasons why, in the flux according to the present invention, each component is added and its composition ratio is limited.

First, we will explain why the sum of three components, Si, Mg and Al contained in the flux is 0.5-1.5% of the total weight of the wire.

Typically, deoxidizing agents have been used to obtain stronger welded portions by removing impurities and gases such as oxygen, nitrogen, hydrogen, etc. in weld metal during welding. Hitherto, Fe—Mn, Fe—Si, Fe—Ti or the like have been predominantly used for this purpose.

While the use of those deoxidizing agents makes it possible to accomplish a deoxidizing effect to some extent, it is hard to obtain arc stability or to adjust the transfer state and size of metal droplets, with respect to weldability.

The present inventors discovered the fact that when Mg and Al metal powder or an alloying agent containing them was contained in the flux and the sum of Si, Mg and Al was set to 0.5-1.5% of the total weight of the wire, it was possible to stabilize arc and to make the transfer of metal droplets fine, simultaneously with maintaining a sufficient deoxidizing effect.

However, if the sum of Si, Mg and Al is less than 0.5% of the total weight of the wire, an insufficient deoxidizing effect is obtained. Also, arc is unstable and blowholes are generated in weld metal. While, if the sum exceeds 1.5%, the amount of produced fumes and the amount of spatter increase and droplets in transfer become large enough to explode. Also, the covering property of slag is reduced and the appearance of a weld bead is coarse and poor. Therefore, the sum of Si, Mg and Al is set to 0.5-1.5% of the total weight of the wire.

Mn is a component for providing a sufficient deoxidizing effect of weld metal, and, at the same time, enhancing the toughness and strength thereof.

If the content of Mn is less than 1.5% of the total weight of the wire, sufficient strength and toughness of the weld metal cannot be obtained, whereas, if it exceeds 2.7%, the strength of the wire is higher than is necessary, causing a poor toughness and an increase of produced fumes.

Therefore, it is preferred that the content of Mn is set to 1.5-2.7% of the total weight of the wire.

Meanwhile, Mn can be added in the form of metal Mn alone or an Mn alloy such as Fe—Mn, Fe—Si—Mn, etc., provided that the requirement for the content of Mn is satisfied.

Mg and Al are components for making the shape of a bead uniform by controlling the solidification rate of weld metal during a horizontal or vertical welding.

When Mg content and Al content in the flux are converted to a summed value of Mg+Al in the total weight of the wire, it is possible to express the ratio of the content of said Mn to the summed value of (Mg+Al), i.e. Mn/(Mg+Al), and this ratio is preferably 3.5-5.0.

If the value of Mn/(Mg+Al) is less than 3.5, the solidification of slag is facilitated, so that a uniform shape of a bead cannot be obtained. If it exceeds 5.0, the solidification of slag is too low, so that a poor distribution of a bead occurs and the amount of spatter and the amount of fumes increase.

Therefore, it is preferred that the value of Mn/(Mg+Al) is set to 3.5-5.0.

Mg and Al can be added in either the form of metal powder or an alloy such as Fe—Al and Mg—Al, provided that all the requirements for the sum of Si, Mg and Al, and the value of Mn/(Mg+Al) are satisfied.

TiO₂ and SiO₂ serve as a slag forming agent. In addition, they improve slag fluidity and arc stability.

If the content of TiO₂ is less than 2.5% or the content of SiO₂ is less than 0.5% of the total weight of the wire, the slag fluidity and viscosity are low, so that when used on a medium or high current condition (in the case of 1.2 mmφ wire, the medium current is 240-280A, and the high current is 300-360A), it is likely to generate undercut in a horizontal fillet position, while increasing the amount of produced spatter and causing droop of a bead in a vertical upward position. Also, if the welding rate is faster, the amount of produced slag is insufficient and the covering property of a bead is poor, causing deterioration of the bead appearance.

On the other hand, if the content of TiO₂ exceeds 9.0% or the content of Sio₂ exceeds 2.0%, slag is excessively generated and due to the weight of the slag, the shape of a bead is poor and arc is unstable. Also, an increase of penetration of non-metallic inclusions into weld metal reduces the strength and toughness of the weld metal.

Therefore, it is preferred that the contents of TiO₂ and SiO₂ are set to 2.5-9% and 0.5-2.0%, respectively.

The TiO₂ and SiO₂ can be added in either the form of Ti and Si powder or ferroalloy and oxide such as rutile, leucoxene, silica, feldspar, mica, etc., provided that the requirement for the contents of TiO₂ and SiO₂ is satisfied.

Cr, Ni, Mo and Nb are components for improving the tensile strength and toughness of weld metal.

If the sum of two or more components selected from the group consisting of Cr, Ni, Mo and Nb is less than 1.0% of the total weight of the wire, the weld metal cannot obtain more than 80 kgf/mm² of tensile strength and toughness, whereas if it exceeds 2.5%, the tensile strength is too large, lowering the toughness. Therefore, it is preferred that the sum of two or more components selected from the group consisting of Cr, Ni, Mo and Nb is set to 1.0-2.5% of the total weight of the wire.

### EXAMPLE

The following will specifically describe examples according to the present invention, as compared with comparative examples, which are outside the scope of the present invention, with respect to the composition and the proportion of flux components.

First, various fluxes each having the composition shown in Table 2 were prepared. Each flux was filled in an outer sheath of mild steel having the chemical components shown in Table 1 to manufacture a first wire, followed by elongation to form a second wire with 1.4 mm diameter. The filling ratio was 15%.

TABLE 1

| Component | C | Si | Mn | P | S |
|---|---|---|---|---|---|
| Wt % | ≦0.03 | ≦0.03 | 0.15 ˜ 0.45 | ≦0.02 | ≦0.02 |

TABLE 2

| | | Chemical components of wire (wt %) | | | | | | | |
|---|---|---|---|---|---|---|---|---|---|
| Examples | | TiO₂ | SiO₂ | Al₂O₃ | MgO | Mg | Al | Mn | Si |
| Inventive | 1 | 6.5 | 1.5 | 0.6 | 0.5 | 0.33 | 0.25 | 2.2 | 0.45 |
| examples | 2 | 6.0 | 1.5 | 0.6 | 0.5 | 0.33 | 0.25 | 2.2 | 0.45 |
| | 3 | 5.0 | 1.5 | 0.6 | 0.5 | 0.33 | 0.25 | 2.2 | 0.45 |
| | 4 | 5.0 | 2.0 | 0.7 | 0.5 | 0.33 | 0.25 | 2.5 | 0.45 |
| | 5 | 5.5 | 2.0 | 0.7 | 0.5 | 0.33 | 0.25 | 2.5 | 0.75 |
| | 6 | 5.5 | 2.0 | 0.6 | 0.5 | 0.33 | 0.25 | 2.5 | 0.75 |
| | 7 | 4.5 | 2.0 | 0.6 | 0.5 | 0.33 | 0.25 | 2.5 | 0.75 |
| | 8 | 4.5 | 2.0 | 0.6 | 0.5 | 0.33 | 0.25 | 2.5 | 0.75 |
| Compara- | 9 | 2.0 | 1.5 | 0.6 | 0.5 | 0.33 | 0.25 | 2.5 | 0.45 |
| tive | 10 | 2.0 | 1.5 | 0.6 | 0.5 | 0.33 | 0.25 | 2.5 | 0.45 |
| examples | 11 | 5.0 | 2.4 | 0.6 | 0.5 | 0.33 | 0.25 | 2.5 | 0.75 |
| | 12 | 5.0 | 2.4 | 0.6 | 0.5 | 0.33 | 0.3 | 2.5 | 0.75 |
| | 13 | 5.5 | 2.0 | 0.6 | 0.5 | 0.6 | 0.3 | 2.5 | 0.75 |
| | 14 | 5.5 | 2.0 | 0.6 | 0.5 | 0.33 | 0.25 | 2.5 | 1.0 |
| | 15 | 4.5 | 2.0 | 0.6 | 0.5 | 0.33 | 0.25 | 3.3 | 0.5 |
| | 16 | 4.5 | 2.0 | 0.6 | 0.5 | 0.33 | 0.25 | 2.5 | 0.5 |

TABLE 3

| | | Chemical components of flux | | |
|---|---|---|---|---|
| | | | | Sum of two or more |
| | | Si + Al + Mg | Mn/ | components of Cr, |
| Examples | | (wt %) | (Mg + Al) | Ni, Mo and Nb (wt %) |
| Inventive | 1 | 1.03 | 3.8 | 1.5 (Cr + N₁) |
| examples | 2 | 1.03 | 3.8 | 1.5 (Mo + Nb) |
| | 3 | 1.03 | 3.8 | 2.3 (Cr + Mo) |
| | 4 | 1.03 | 4.3 | 2.3 (Mo + Nb) |
| | 5 | 1.33 | 4.3 | 2.3 (Cr + Mo) |
| | 6 | 1.33 | 4.3 | 2.0 (Cr + Nb) |
| | 7 | 1.33 | 4.3 | 2.0 (Ni + Mo) |
| | 8 | 1.33 | 4.3 | 2.0 (Ni + Nb) |
| Comparative | 9 | 1.03 | 4.3 | 0.8 (Mo + Nb) |
| examples | 10 | 1.03 | 4.3 | 0.5 (Cr + Ni) |
| | 11 | 1.33 | 4.3 | 0.9 (Cr + Mo) |
| | 12 | 1.38 | 3.96 | 2.7 (Ni + Mo) |
| | 13 | 1.65 | 2.8 | 2.0 (Cr + Nb) |
| | 14 | 1.58 | 4.3 | 2.0 (Ni + Nb) |
| | 15 | 1.08 | 5.68 | 2.0 (Cr + N₁) |
| | 16 | 1.08 | 4.3 | 3.0 (Cr + Nb) |

If a flux is composed of chemical components according to the composition ratio shown in Table 2, main components of the flux follow the composition ratio shown in Table 3. The weight % in Table 3 is based on the total weight of the wire.

Table 4 describes the welding conditions of the flux cored wires manufactured according to respective composition ratios shown in Table 2 and Table 3. The results of welding tests are presented in Table 5.

TABLE 4

| Section | Welding conditions | |
|---|---|---|
| Test plate material | Rolled steels for welding structures SM490A | |
| Test plate material | thickness 12 mm, width 100 mm, length 300 mm | |
| dimensions | | |
| Welding position | Horizontal fillet position | Vertical upward |
| | | position |
| Welding current | 340 A | 240 A |
| Welding voltage | 32 V | 26 V |
| Welding speed | 40 cm/min | — |

| | |
|---|---|
| Shield gas | 100% CO₂ |
| Shield gas flow rate | 20 ρ /min |

TABLE 5

| | | Welding workability | | | | | | | |
|---|---|---|---|---|---|---|---|---|---|
| | | Horizontal fillet | | | | Vertical upward | | | |
| | | | | Detach | Amount of | | | Detach | Amount of |
| | | Arc | Shape | ability | produced | Arc | Shape | ability | produced |
| Examples | | stablilty | of bead | of slag | spatter | stability | of bead | of slag | spatter |
| Inventive | 1 | ⊚ | ◯ | ◯ | ◯ | ◯ | ◯ | ◯ | ◯ |
| examples | 2 | ⊚ | ◯ | ◯ | ◯ | ◯ | ◯ | ◯ | ◯ |
| | 3 | ⊚ | ⊚ | ⊚ | ◯ | ⊚ | ⊚ | ⊚ | ◯ |
| | 4 | ⊚ | ⊚ | ⊚ | ◯ | ⊚ | ◯ | ◯ | ◯ |
| | 5 | ⊚ | ⊚ | ⊚ | ◯ | ⊚ | ⊚ | ⊚ | ◯ |
| | 6 | ⊚ | ⊚ | ⊚ | ◯ | ⊚ | ⊚ | ◯ | ◯ |
| | 7 | ⊚ | ⊚ | ⊚ | ◯ | ⊚ | ⊚ | ◯ | ◯ |
| | 8 | ⊚ | ◯ | ⊚ | ◯ | ⊚ | ◯ | ◯ | ◯ |
| Comparative | 9 | X | Δ | Δ | Δ | Δ | Δ | Δ | Δ |
| examples | 10 | X | Δ | Δ | Δ | Δ | Δ | Δ | X |
| | 11 | ◯ | ◯ | ◯ | Δ | Δ | Δ | ◯ | X |
| | 12 | ◯ | Δ | Δ | X | ◯ | Δ | ◯ | X |
| | 13 | Δ | Δ | Δ | X | Δ | ◯ | Δ | X |
| | 14 | Δ | ◯ | ◯ | X | Δ | ◯ | ◯ | X |
| | 15 | Δ | Δ | ◯ | Δ | Δ | ◯ | ◯ | Δ |
| | 16 | Δ | Δ | Δ | Δ | Δ | ◯ | ◯ | Δ |

The evaluation of welding performance in Table 5 is as follows: ⊚:very good, ∘: good, Δ:average, X:poor.

To accomplish the mechanical and physical tests of weld metal, test specimens were manufactured according to the procedures of AWS standard under the welding conditions shown in Table 6. Table 7 shows the evaluation results of the welded metal under the welding conditions shown in Table 6.

TABLE 6

| Section | Welding conditions |
|---|---|
| Test plate steels | Rolled steels for welding structures |
| | SM490A |
| Test plate dimensions | Thickness 19 mm, width 150 mm, |
| | length 300 mm |
| Groove angle | 45° |
| Root space | 12 mm |
| Number of passes and layers | 17 passes 6 layers |
| The temperature between layers | 150° C. |
| Shield gas | 100% CO₂ |
| Welding current | 260 A |
| Welding voltage | 32 V |

TABLE 7

| | | Results of tensile strength and impact tests | |
|---|---|---|---|
| Examples | | Tensile strength (kgf/mm²) | CVN (j, −18° C.) |
| Inventive | 1 | 78 | 60 |
| examples | 2 | 79 | 62 |
| | 3 | 80 | 58 |
| | 4 | 79 | 63 |
| | 5 | 81 | 60 |
| | 6 | 84 | 55 |
| | 7 | 82 | 63 |
| | 8 | 82 | 63 |
| Comparative | 9 | 73 | 21 |
| examples | 10 | 72 | 23 |
| | 11 | 83 | 33 |
| | 12 | 82 | 32 |
| | 13 | 82 | 33 |
| | 14 | 84 | 24 |
| | 15 | 88 | 20 |
| | 16 | 90 | 18 |

As can be seen from Table 5 and Table 7, the wires of examples 1-8, in which the composition and proportion in their flux components were within the scope of the present invention, exhibited good welding workability both in a horizontal fillet position and a vertical upward position. Also, they maintained high tensile strength and had good absorption energies in a Charpy impact test at −18° C.

On the other hand, in the wires of comparative examples 9-16, welding workability was poor or tensile strength and impact absorption energies were low because one or two of the chemical components contained in the flux was/were out of the range(s) defined in the present invention.

In the wires of comparative examples 9 and 10, general welding workability was poor, for example, arc stability and slag detachability were low and the amount of produced spatter increased because added amounts of TiO₂ were less than 2.5%.

In the wires of comparative examples 11 and 12, unevenness of the shape of a bead was severe and in particular, the amount of produced spatter increased in a vertical upward welding because the added amounts of SiO₂ exceeded 2.0%.

In the wires of comparative examples 13 and 14, their arc stability was poor and the amount of produced spatter increased because the sum of Si, Al and Mg was over the range defined in the present invention. Therefore, judging from the results, the wires exhibited poor welding workability.

In the wire of comparative example 15, tensile strength was high but impact absorption energy was poor because the value of Mn/(Mg+Al) was over the range proposed in the present invention resulting from the content of Mn exceeding 2.7%.

In the wire of comparative example 16, like as in the comparative example 15, tensile strength was high but impact absorption energy was very low because the sum of two or more components of Cr, Ni, Mo and Nb exceeded 2.5%.

Accordingly, it is understood that the wires which are within the scope of the present invention are good in welding workability and mechanical and physical properties whereas the wires which are outside the scope of the present invention are very poor in welding workability and mechanical and physical properties.

As described in the above, the flux cored wires for gas shielded arc welding in accordance with the present invention, when optimizing the chemical components and their proportion of the flux, exhibit good welding workability in all welding positions, ensuring an improvement in the efficiency of welding work, and maintain high tensile strength and impact absorption energy, ensuring stability of welded structures.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A flux cored wire for gas shielded arc welding of high tensile strength steel, the flux being enclosed by an outer sheath of mild steel, characterized in that the flux essentially consists of, with respect to the total weight of the wire:
metal or ferroalloy containing at least Si, Mg and Al acting as a deoxidizing agent, the sum of the Si, Mg and Al being from 0.5 to 1.5%,
from 1.5 to 2.7% Mn, provided that the ratio of Mn to (Mg+Al), (Mn/(Mg+Al)), is 3.5-5.0,
from 2.5 to 9.0% TiO₂ and from 0.5 to 2.0% SiO₂, as a slag forming agent, and
two or more components selected from the group consisting of Cr, Ni, Mo and Nb, the sum of the two or more components being 1.0-2.5%.
